(19) United States
(12) Patent Application Publication
(10) Pub. No.: US 2015/0100346 A1
(43) Pub. Date: Apr. 9, 2015

(54) System and method for verification of identity in an integrated health network

(71) Applicant: Kendra E. Wendt, Phoenix, AZ (US)

(72) Inventor: Kendra E. Wendt, Phoenix, AZ (US)

(21) Appl. No.: 14/544,240

(22) Filed: Dec. 12, 2014

Related U.S. Application Data
(63) Continuation-in-part of application No. 13/247,542, filed on Sep. 28, 2011, now abandoned.
(60) Provisional application No. 61/387,383, filed on Sep. 28, 2010.

(51) Int. Cl. G06F 19/00

(52) U.S. Cl. CPC G06F 19/327
USPC 705/2

(57) ABSTRACT

A identity verification device for verifying identity used in a system and process for aiding the transition of patients to and from the post acute market, and more specifically to a computer based system for facilitating the transition and an application program for doing so in a networked computer environment. The system may include advertising, the transfer of employment records, and the networking of vendors to coordinate the provision of services.

### CROSS-REFERENCE TO RELATED APPLICATION

This application is a continuation in part of U.S. patent application Ser. No. 13/247,542, filed Sep. 28, 2011, which is in turn claims the benefit of U.S. Provisional Patent Application No. 61/387,383 filed Sep. 28, 2010, the contents of which are hereby incorporated by reference.

### TECHNICAL FIELD

This description relates generally to an identity badge or card reading device to verify credentials of an in network provider for use in a system for aiding the transition of patients to and from post acute care facilities and more specifically to a computer based system and method for facilitating the transition by utilizing computer networking.

### BACKGROUND

Today's healthcare industry is faced with daunting challenges. Clinicians want to enhance the quality of care for their patients and increase accessibility, while reining in exorbitant healthcare costs. Left unchecked health expenditures will increasingly consume higher percentages of the Gross Domestic Product (GDP). Groups including hospitals, insurers, doctors, pharmaceutical companies, and medical device companies, could decrease their costs. A large percentage of these savings could come from changes in utilization of care, administration simplification, and the cost of doing business. In particular, savings could be obtained in the areas of improved care coordination and implementing health information technology.

A patient being discharged from a hospital is often not ready to go home, or able to continue living on their own. To find care staff at the hospital, or the family may have to call, fax, visit, or otherwise spend great effort locating a post acute care facility. Often a patient may be transferred, or be in the process of being transferred when it is discovered that the target facility may not have the room, staff, equipment or other component needed to care for the transferring patient. Such a mismatch is inefficient, and does not do the patient's health any good, if their need are not met. Improved care transitions of patients between care facilities can avoid hospital readmissions to create cost savings. For example a patient may be moved and then because care or the equipment at a facility may be lacking, the patient may end up being readmitted to the hospital. This often happens, and is not good for the patient's health and is costly as well. Also, the utilizing the benefits of health information technology will ultimately reward quality and value while empowering patients to engage effectively in the healthcare system.

Presently, inefficiencies in discharge planning cost the healthcare industry more than $12 billion a year. Case managers in acute care facilities are paid at least $80,000 a year to help discharged patients transition to post-acute care environments like skilled nursing facilities or assisted living homes. However, systemic difficulties often ensue: patients are transitioned to the wrong type of facility, or they do not have the proper medical equipment or supplies when they arrive. Additionally, there are not enough physicians and nurses to provide adequate attention to administrative matters, like transitioning patients to and from post-acute care facilities. This leads to patients and their families feeling angry, vendors frustrated at lost sales opportunities, and increased burnout with healthcare professionals. The heart of the problem is waste: wasted time, wasted dollars, and wasted opportunities for better communication and sustainable revenue generation. Accordingly it is desirable to provide a device that verifies the credentials of a provider within such a system.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides the networked use of health information technology in hospitals and in association with other providers to improve efficiencies and reduce healthcare costs in transitioning patients between facilities, typically called for when their care needs change.

The integrated health network (“IHN”) is a computer based network system and a method that implements processes such as the facilitation of bed transfers in healthcare to provide patients, families, healthcare providers, and related professionals, a convenient, centralized networking system in real-time. The IHN's system improves processes efficiencies, transitions, outcomes, and profitability throughout the healthcare continuum while enhancing patient satisfaction. The IHN also integrates with outside vendors such as real estate brokers that can help liquidate real estate for patients that no longer need a home, and other vendors such as medical equipment supply houses, and staffing agencies.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates the interaction of various people and organizations in providing health care as a patient transitions their care between various organizations.

FIG. 2 shows the subdivision of the integrated health network into functionalities of a vendor service network and a network for providing efficient bed transitions of patients from one facility to another

FIG. 3 shows further details of the three exemplary components of the integrated health network.

FIG. 4 shows further details of the vendor network process.

FIG. 5 shows further details of the bed transition process.

FIG. 6 is a flow diagram showing the process of bed transitions.

FIG. 7 shows the n-tier programming structure of the integrated health network web based application.

FIG. 8 illustrates an exemplary computing environment 100 in which the facilitation of bed transitions in health care described in this application, may be implemented.

FIG. 9 is an exemplary network in which the facilitation of bed transitions in health care may be implemented.

FIG. 10 is an exemplary home page for the facilitation of bed transitions in health care system.

FIG. 11 is a block diagram if an identity verification device.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a web based computer network. Although the present examples are described and illustrated herein as being implemented in Internet based system, the system described is provided as an example and not a limitation. As those skilled in the art will appreciate, the present examples are suitable for application in a variety of different types of networks and systems including WANs, LANs and the like.

The system and method described herein is described as a web based application. The integrated health network process may be implemented as one or more computer software applications hosted through a web browser environment and/or coded in a browser-supported language (such as JavaScript, HTML or the like) and utilizing a web browser disposed upon a PC to render the application accessible through the internet or other network (WAN, LAN, or the like) to users, with the main program residing on one or more server systems coupled to the internet.

The integrated health network may be implemented in an exemplary multi tier architecture (usually including representative presentation, application and storage tiers) in which web based presentation (GUI) tier makes requests to the server based middle or application tier, or tiers, which in turn accesses a data base on a lower tier to service the middle tier or tiers. Such layered, or tiered programming structures allows for efficient programming structures by separating computer languages and functions implemented on different layers or tiers. However in equivalent implementations any convenient programming structure, and language, or languages may be used to implement the integrated health network system and method.

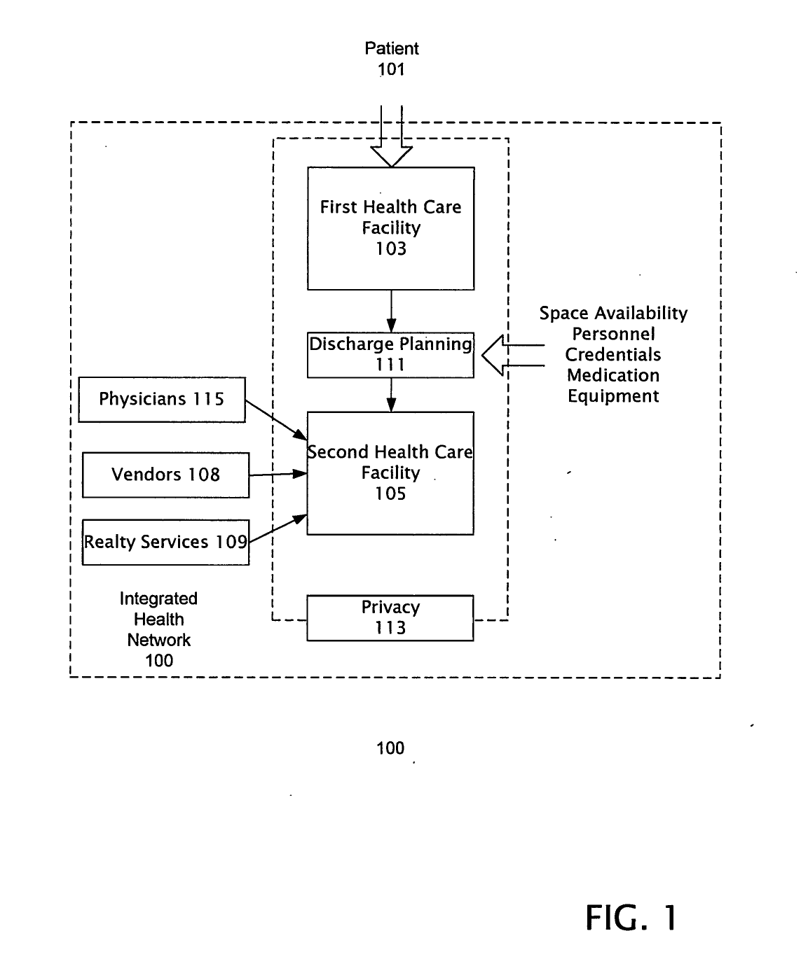

FIG. 1 illustrates the interaction of various people 101 and organizations 111, 105, 107, 109 in providing health care as a patient 101 transition their care between various organizations 103, 105. The exemplary integrated health network web-application creates an environment 100 that couples the various entities involved during a patient's discharge process. The integrated health network also provides verifications that services are available to discharge planners 111 seeking to place a patient 101. Alternatively the patient 101, or their representative may place themselves in a second health care facility 105 by accessing and utilizing the functions of the integrated health network 100. Patient privacy is also maintained through the implementations of programming structures 113 that are HIPPA compliant.

This innovative process, which forms the theme of the web based application ensures the bring together of various entities such as vendors 107, hospitals 103, physicians 115, patients 101, nursing facilitators/case managers 111, assistive living providers 105 and other applied health care professionals etc, together in a networked environment, and also automates the discharge process as well as provides other add on services 109. As part of the process user friendliness is provided, the proposed solution ensures ease of use of the system is present in order to provide a process that has been made usable as well as efficient and cost effective. The solution integrates various vital entities within the healthcare industry, and especially those involved in patient transfer. The networked connection via a web managed environment of all the involved entities or actors ensure the efficient provision of services in the bed transfer process.

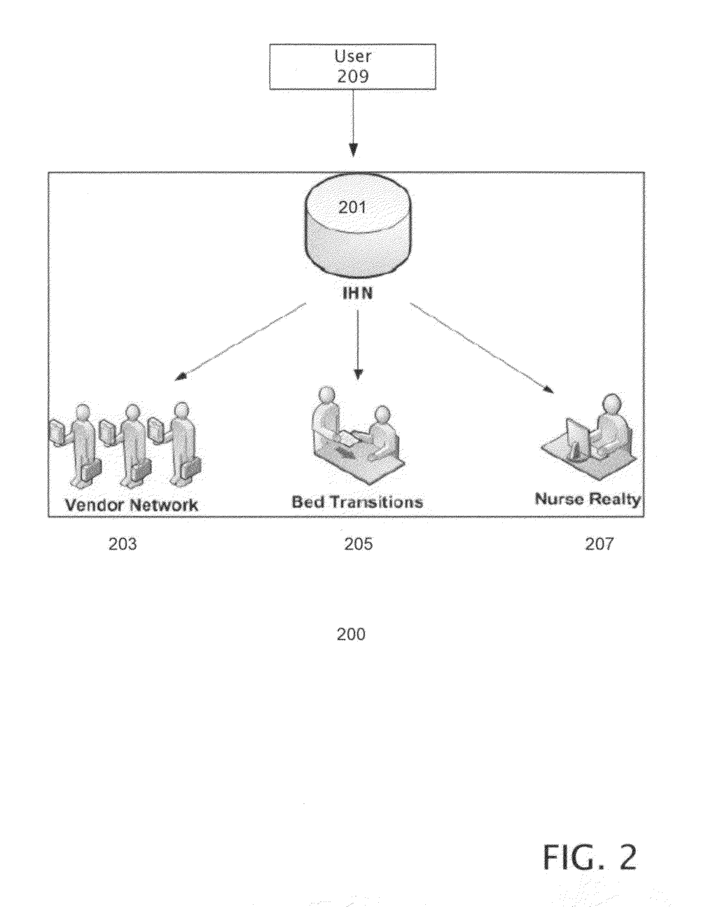

FIG. 2 shows the subdivision of the integrated health network system into functionalities of a vendor service network and a network for providing efficient bed transitions of patients from one facility to another. The integrated health network system and method 100 described herein provides a portal that is a common location 201 that brings together healthcare vendors 203 listing their services and advertisements with those needing the services-primarily health care facilities and individuals 209. In facilitating bed transitions 205 the portal 201 provides features including bed censuses and virtual tours that help vendors, facilities and family members to know the needs of a facility or patient, and have a view of the new facility without leaving the patient behind. The exemplary portal 201 described herein includes:
ASP.net based development for the website.
The portal includes various third party tools integrations such as those for converting formatted flyers to the PDF files for ease of distribution.
The portal includes the functionality of virtual tours with the help of images and videos. All videos uploaded will be converted to flash compatible videos so that videos players are not needed for viewing the videos. Flash videos player will be integrated for displaying the videos.
Analytics services may be integrated in the portal so that administrators can have the detailed reports on traffic and hits.
Analytics and reporting tools utilized by various actors that are members of the network to account for and report existing inventories, including beds available and facility capabilities available and ordered to care for a transferring patient.
provision for chatting in the application may be provided via third party chat applications or their equivalent
The portal includes a payment gateway integrated into the website for advertisement payments and payment for membership for bed transition memberships by users.
A super admin manages the overall website and has the ability to login into any vendor's login area.

There are actors of various entities that may be networked by the system described herein and provision is made for their access to the system. Actors in general are those users of the system who directly or indirectly interact with the system. There are back office users that can be further divided into two categories of super-admin users and sub-admin users. The super admin user is typically a person who controls the functioning of the web site, and is usually ultimately responsible to ensure the site is functioning properly and also has authority to manage website from their back office. A sub admin users created by super admin user may be assigned different sections of the site to manage that are controlled by the back office.

The super admin of the application controls the overall flow of the application and manages the different areas of application. This allows the super administrator to monitor the overall application with the functionalities of the super-admin covering areas that may include: the login area, sub-admin management, content management, membership management, payments tracking, listing management and tracking, managing public listings and virtual tours, view unchecked bed transition requests, e-mail templates management, marketing material management, facility to manage any vendor login or the like.

Vendor users interact directly with the system can be divided into the categories described above. The vendor categories can include vendor super admin users and vendor sub admin users.

Public users interact indirectly and this group may include patients or the associated family members. This user type bears the charged membership, and are provided with limited accessibility and would be allowed access to the following features: search, virtual tours, reference links to vendor sites. If a patient wants to directly contact a vendor and they don't have primary physician, a contact or referral form or sheet may be provided, where the patient will complete the form and send it to that vendor. Further it is typically up-to vendors to get back to the patient by any convenient method under such circumstances.

The integrated health network (IHN) 201 described herein networks the various actors or parties 203, 205, 207, 209 in the healthcare continuum, creating better communication, recovering lost revenue, building new revenue opportunities, and ensuring that patient transitions becomes a streamlined, effortless process. Hospitals, skilled nursing facilities, assisted living facilities, group homes, acute care facilities, post-acute long-term facilities, physicians, nurses, durable medical equipment companies, families, patients, physician offices, and more—essentially any party related to healthcare—can become a member of the IHN online community to improve the efficient delivery of services. IHN provides a secure web based network that meets the needs of substantially the entire healthcare continuum.

IHN can also associate with related service providers such as real estate companies 207 that can provide services health care recipients may need. For example a real estate company such as the exemplary Nurse Realty, is a full real estate company focusing in the health care market that provides on the ground sales support to health care organizations, health care professionals vendors, patients, and their families while the commercial sector of NR focuses on commercial health care leasing and sales.

The integrated health network in particular includes two sections, a vendor network functionality 203 and bed transitions functionalities 205. The vendor network 203 system allows medical vendors to market, network, and advertise products and services within the network. The vendor network 203 allows vendors to interface and pool resources, by specialty (such as wound care treatment suppliers), and market to acute care and post acute care facilities, vendors, physician groups and others who might be part of the bed transition system 205, providing services to various users 209.

The bed transitions sub system 205 specifically focuses on streamlining the entire patient discharge system. The bed transitions sub system is designed to reduce the headache and heartache involved in sending loved ones to new care facilities, and it includes virtual tours of facilities, and useful information such as bed availability and other amenities to help make the process easier. From the stand point of the facilities administrator the system tracks the amenities available at a facility, that are available for a bed and tracks and reports what is available not only in terms of beds available, but services associated with that bed that are needed by the transferring patient.

For example in bed transitions online implementation of discharge process and easy patient transitioning between facilities is a functionality provided by IHN. The system helps in managing the transfer of patients from one location to another without the worries for looking the new location, which is often done by phone, fax, or by physically making a visit. All the facility information may be available online so that the facility transferring to another location or the patients can easily view the features available with new facility. Pictures, video clips and the like may be integrated into the system.

In an alternative example the system may be divided in to three exemplary functionalities: vendor networked services 203, bed transition services 205, and unique to this example, realty services 207 for patients. The realty services functionality 207 provides a system that facilitates the dissolution of real property assets of patients entering long term care, or permanent care facilities. The realty system receives leads from the IHN. In turn, the realty system tracks these leads and conversions, while performing other “back office” tasks that may be useful to subscribers helping to liquidate property.

The portal 201 provided by the IHN provides computer based networked integration of automated functions that have not previously been easily shared between facilities. That is the records and function in a facility may be automated within their own computer network, but that locally available networked information may not be available to other entities such as skilled care facilities, medical supply vendors, staffing agencies and the like. HIPPA regulations also make information sharing difficult. However, the system described herein is typically HIPPA compliant and provides an environment to facilitate the transfer of information, and matching patients to resources available.

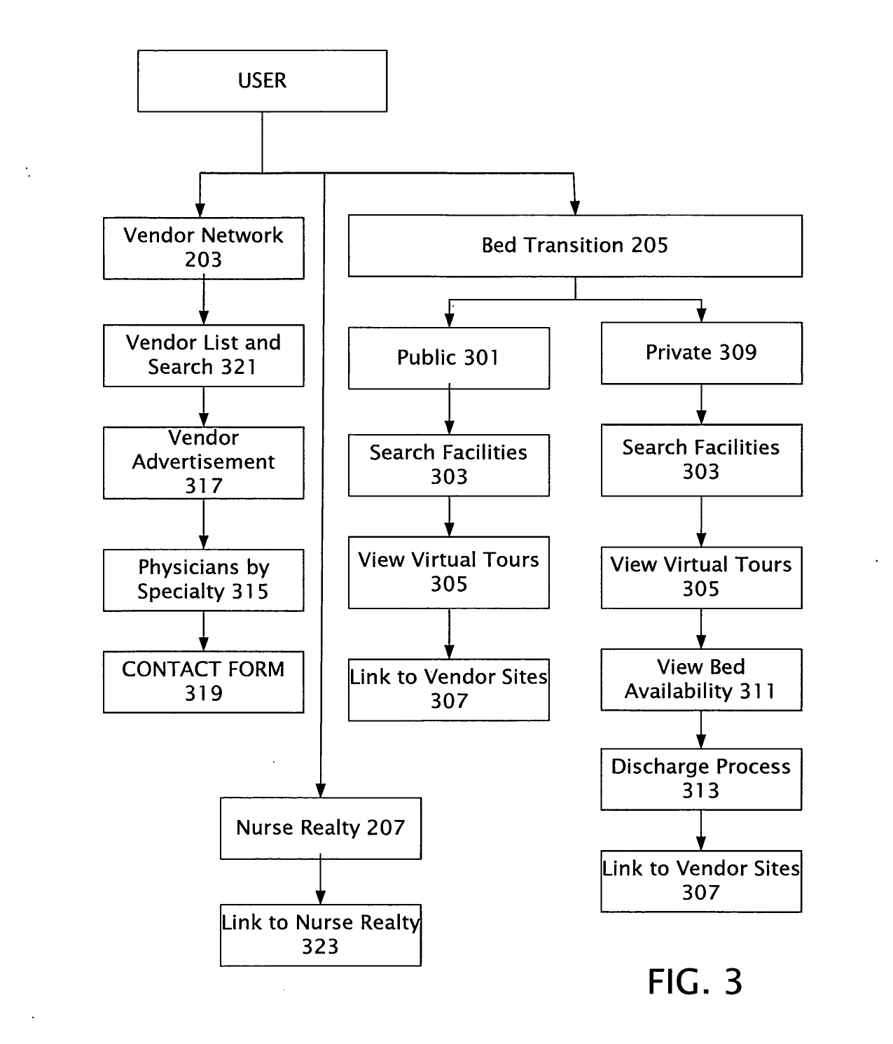

FIG. 3 shows further details of the three exemplary components of the integrated health network. Bed Transitions is the sub system of the IHN that bridges the transitions process from acute care to post-acute (and back), vendors, and others. All parties via a portal for public access 301 will search facilities 303 for bed availability in real time and review the results through virtual tours 305, photos or the like (a simple GUI displayed list, or equivalent) may also be provided. Also links to vendor sites 307 can allow the public access to services for the bed transitioned into. This is ideal for families, since they will never have to leave the bedside of the patient. Follow-up and quality assurances for health care are also included. It should be noted that patients and their families will only have limited access to IHN, viewing facilities and joining the network a month at a time.

Services similar to those available, to the public 301 may be provided through a private gateway 309 in the bed transition subsystem 205. Here to aid institutions planning a discharge bed availability 311 may be determined, and the discharge process 313, may be facilitated 313.

Vendor networks 203 helps in locating the vendors and physicians based on the location and other credentialed health care providers whose services might be needed 315. In addition a vendor list may be provided as well a general search function 321. The vendor networking system may be sub-segmented by specialty (such as wound care and respiratory disease), where members of the network can advertise by specialty (for a fee) 317 and network with others 319 within that specialty, as well as patients and their families.

Nurse Realty's residential real estate portal 207 focuses on transitioning patients from home into healthcare facilities (acquiring the listing from patient/family transitioning) and the commercial aspect involve leasing medical office buildings, assisted living, group homes, and land acquisitions for health care development. Nurse Realty creates a direct link 323 on the Innovative Health Networks website that takes members to Nurse Realty if they require a licensed agent. Furthermore, Nurse Realty may allow paid subscribers to have a zip code territory.

In a further alternative example a portal offering the services of providing mobile employee records (“MER”) (not shown) may be provided in similar fashion to providing the nurse realty portal. The portal includes:
A place for Employees to house employee records with universal employer access to all employers via access granted through password protected permission.
The Employers will become a member to be able to transfer and retrieve data via permission from the employee.
The fee per employee may be based on an annual fee or other suitable financial criteria.
The fee per employer will be based on an annual fee or other suitable financial criteria
The layout out design typically identifies the type of industry via a drop down box for employers
The Employee information is protected and not identified unless the employee gives access to an employer to transfer data.
The information housed for each employee may be in folder format, or other suitable format:
   a. Including different categories, such as:
      i. Resume—a built template so when a person changes jobs it can be updated and maintained within the site.
      ii. Certifications
      iii. Licensure state specific
      iv. Honors
      v. Compliance related mandatory continued education
      vi. Compliance related requirement for type of position. E.g. CPR or OSHA for HC, etc.
      vii. Additional Training completed
The home page may have several places for employers to advertise their business-animated banner ads, etc.
The homepage ads can be another revenue stream. So, additional advertisement placement may be provided.
The website home page may have many places for employers to advertise but fairly simple otherwise, and typically includes:
   a. Included Tabs
      i. About us—to include mission, vision, meet our team
      ii. Service—would include Employer Management and Personal Management
      iii. Advertise
      iv. Training
      v. Contact US
This application is available through the IHN system, typically as an add on service
The solution is web-based so the records would can utilize a transfer process built in to the protected environment and includes an up/down load feature via employee permission. The feature includes a way to identify which records the employee is giving permission to the employer to access. For example it may be only be one or two records, or the employee's total folder.
Training is available as a further ad on application for universal training via web ex. Also, available as an ad on feature is an application for employers to post their training on our site for a fee and direct the results to the actual employees personal file and employer record
The Employee and Employer manage the data and information under their control,
The Information is stored in a data warehouse as the data may be extensive and very large in volume.

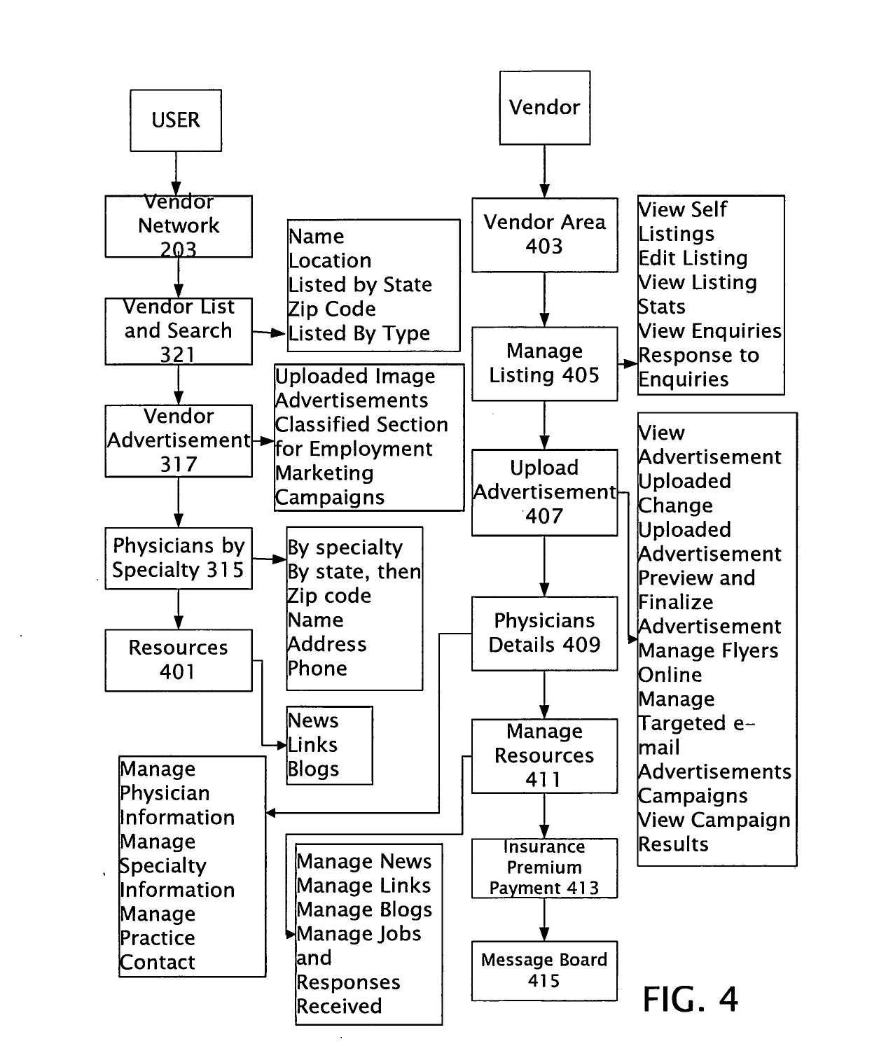

FIG. 4 shows further details of the vendor network system 203 and the additional vendor area 403 that is available for access by a vendor alone. The vendor network subsystem of the IHN provides a main portal or “master site” 403 for medical vendors (including manufacturers and or sellers of medical instruments, hospital equipment suppliers, and insurance providers, and others) to market, advertise, and network. The network also provides a centralized area for vendors to pool information and resources. For example classified advertising 405, 407 can be made available to vendors who wish to advertise by specialty (or other equivalent criteria) for a fee.

The vendor network provides a place for centralized advertisement for healthcare vendors. Paid advertisements for the vendors may typically be listed on payment of a fee according to the type of facility, vendor, specialty type or other criteria that may be desired to be used to set a fee. Vendors upload picture advertisements from the login area. There are also convenient links available for insurance payers to send payments to their respective insurance company 413. A job board and or message board 415 is available for employees of vendors as well as healthcare professionals.

A capability to manage the listing 405 is provided in which a vendor may view and edit their listing, view statistical data provided regarding their listing, and view and respond to inquiries made regarding their services. An area to upload advertising 407 is provided. It allows a user in this portal to view and edit uploaded advertisements, preview their advertisements, manage online flyers that they may provide, manage e-mail advertising campaigns, create and manage advertising campaigns.

In the area accessible to a user 203, vendor list and search 321 can include listings and searches made/provided by name, location, zip codes, type of listing and the like. In the vendor advertisement section 317 a user can access vendor . advertisements, download them and view advertisement, including advertisement provided by a planed ad campaign. Physicians by specialty 315 may also be found based on such criteria as specialty, state, zip code, name address, phone, and the like. And finally a resource area 401 is available to the user where news, links and blogs may be available.

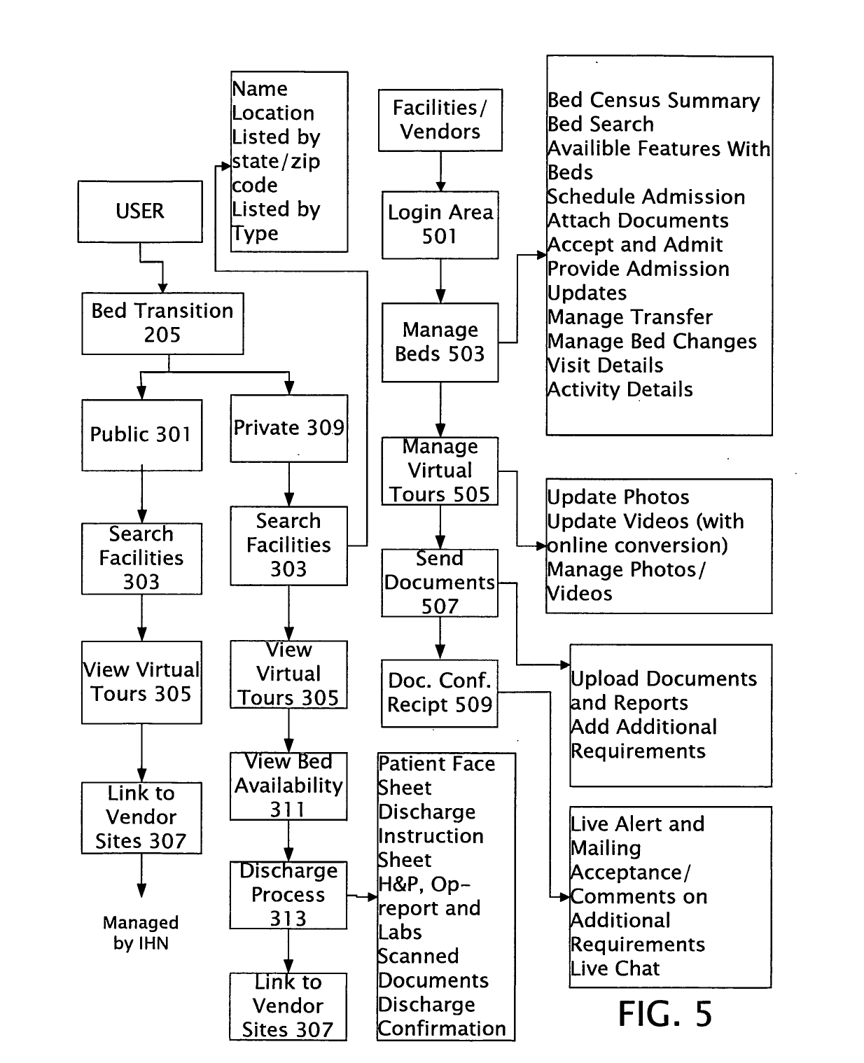

FIG. 5 shows further details of the bed transition process. The User accessed features are as previously described. The systems accessible by facilities or vendors 500, includes a login area 501 where facilities or vendor may log in to manage their services and perform other tasks that help manage and automate the transfer process. A portal to manage beds 503 id provided. This portal includes processes that allow a bed search to be performed, as well as a bed census to be obtained. Admissions may be scheduled and feature that are available with a bed are tracked here. Acceptance and admission can be obtained here and admission updates may also be provided. Further provided are tools to manage the transfer, and bed changes as well as to provide visit details and activity reports.

Management of virtual tours 505 is a process that allows for the management and uploading of photos and videos. Functionalities are also included to provide online conversion of the video stream. A process that allows for the sending of documents 507 facilitates the use of the networked system. The system provides secure communications and an easy way to establish communications from within the network. Documents and reports may be uploaded and additional requirements as needed may be added to the system. To improve communications in the secure environment live chat may be included as well as providing live alert functions and also allowing acceptance and comments on additional requirements that may be needed. Members can create different marketing campaigns which are saved in a gallery that can be activated and deactivated for a fee, upon the members request.

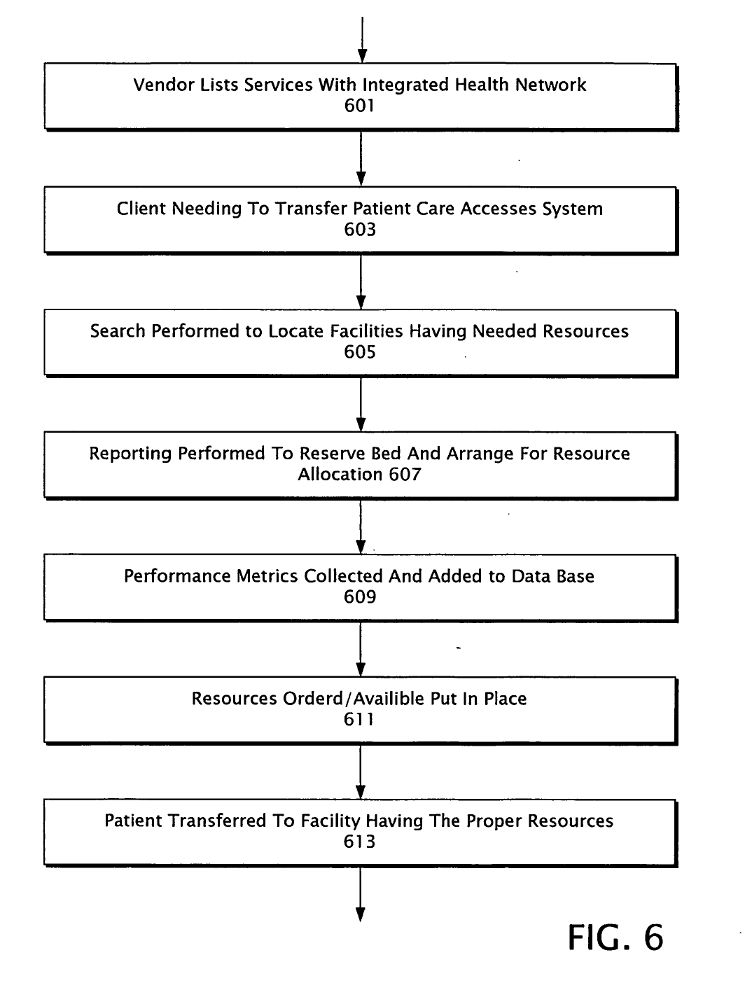

FIG. 6 is a flow diagram showing the process of bed transitions. First one or more vendors subscribe to the integrated health network as described herein. A client needing to transfer to a new facility accesses the integrated health network 603, and performs a search 605 to locate a facility meeting their needs. The client reserves a bed and reporting is performed 607 to make sure that the bed is reserved and the needed resources are in place by the anticipated transfer date. Performance metrics may be collected and added to the data base 609 so that interested parties may judge the performance of the integrated health network in delivering their services. At 611 the recourses if not already in place are ordered and made available in anticipation of the transfer 611. The patient is transferred 613 with the proper resources being available for their care.

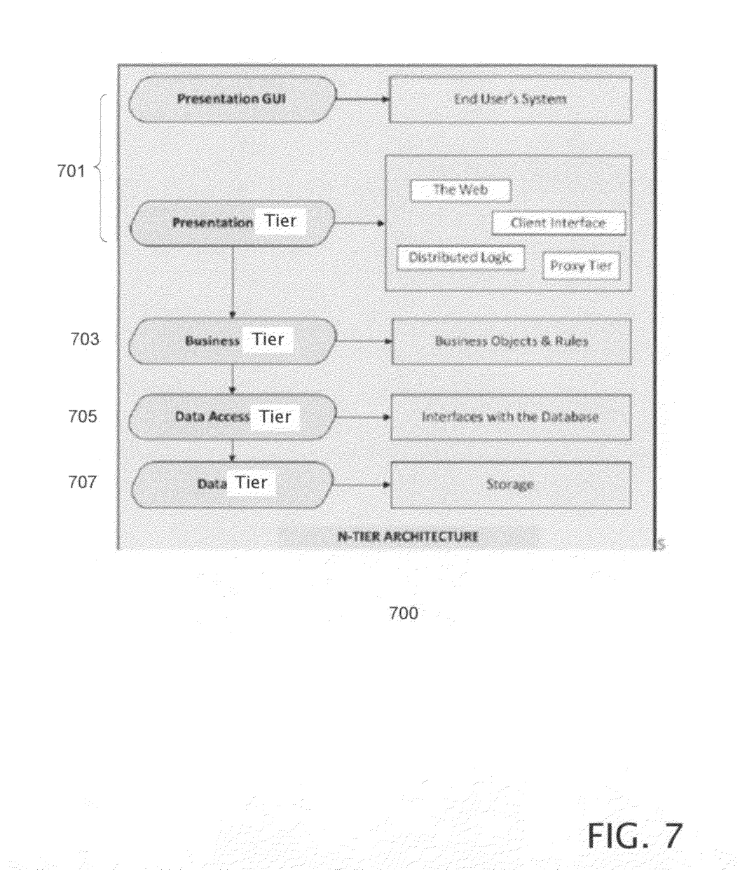

FIG. 7 shows the n-tier programming structure of the integrated health network web based application. The application architecture is an N-tier architecture 700. An n-Tier application usually has four tiers, and they may be called the presentation tier 701, the business tier; data access tier and the data tier. Each tier is responsible for various tasks.

The presentation tier 701 is responsible for displaying the user interface and “driving” that interface. Business Tier 703 & Data Access Tier 705: These tiers are the layers responsible for accessing the data tier to retrieve, modify and delete data to and from the data tier and send the results to the presentation tier. This tier is also responsible for processing the data retrieved and sent to the presentation tier. Often these are separately known as: the Business Logic Layer (BLL), and the Data Access Layers (DAL). Business Logic Layers are above Data Access Layers, meaning BLL uses DAL classes and objects. DAL is responsible for accessing data and forwarding it to BLL.

Data Tier 707 is the database or the source of the data itself. Often in .NET it's an SQL Server or Access database, however it's not limited to just those. It could also be Oracle, mySQL or XML. In the present application the development focus has been on SQL Server, as it has been proven to be a fast database within a .NET Application.

The core benefits of such a system may include the true separation of code. This system 700 provides a method by which modules of the application can be fully contained, and where the business logic does not have to rely on the reactions that occur from the processing. In addition, upgrades to such a system become much simpler because many upgrades can be made by adding an assembly with a new module and never touching the rest of the deployment.

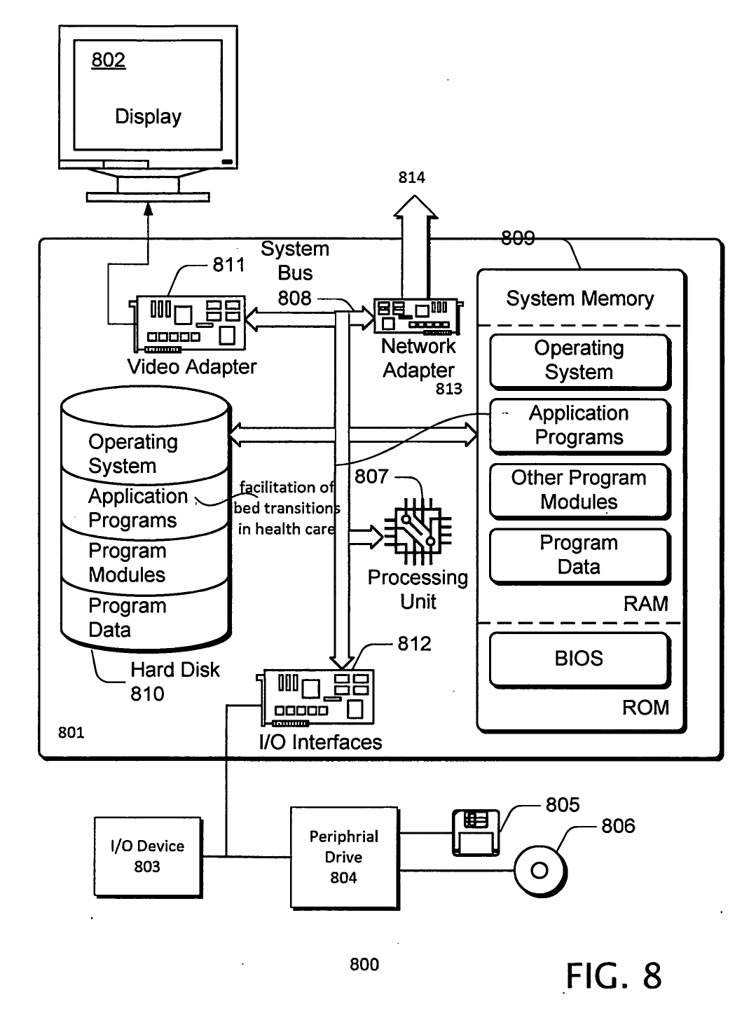

FIG. 8 illustrates an exemplary computing environment 800 in which the facilitation of bed transitions in health care described in this application, may be implemented. Exemplary computing environment 800 is only one example of a computing system and is not intended to limit the examples described in this application to this particular computing environment.

For example the computing environment 800 can be implemented with numerous other general purpose or special purpose computing system configurations. Examples of well known computing systems, may include, but are not limited to, personal computers, hand-held or laptop devices, microprocessor-based systems, multiprocessor systems, set top boxes, gaming consoles, consumer electronics, cellular telephones, PDAs, and the like.

The computer 800 includes a general-purpose computing system in the form of a computing device 801. The components of computing device 801 can include one or more processors (including CPUs, GPUs, microprocessors and the like) 807, a system memory 809, and a system bus 808 that couples the various system components. Processor 807 processes various computer executable instructions, including those to facilitation of bed transitions in health care to control the operation of computing device 801 and to communicate with other electronic and computing devices (not shown). The system bus 808 represents any number of several types of bus structures, including a memory bus or memory controller, a peripheral bus, an accelerated graphics port, and a processor or local bus using any of a variety of bus architectures.

The system memory 809 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 807.

Mass storage devices 804 may be coupled to the computing device 801 or incorporated into the computing device by coupling to the buss. Such mass storage devices 804 may include a magnetic disk drive which reads from and writes to a removable, non volatile magnetic disk (e.g., a “floppy disk”) 805, or an optical disk drive that reads from and/or writes to a removable, non-volatile optical disk such as a CD ROM or the like 806. Computer readable media 805, 806 typically embody computer readable instructions, data structures, program modules and the like supplied on floppy disks, CDs, portable memory sticks and the like.

Any number of program modules can be stored on the hard disk 810, Mass storage device 804, ROM and/or RAM, including by way of example, an operating system, one or more application programs, other program modules, and program data. Each of such operating system, application programs, other program modules and program data (or some combination thereof) may include an embodiment of the systems and methods described herein.

A display device 802 can be connected to the system bus 808 via an interface, such as a video adapter 811. A user can interface with computing device 702 via any number of different input devices 803 such as a keyboard, pointing device, joystick, game pad, serial port, and/or the like. These and other input devices are connected to the processors 807 via input/output interfaces 812 that are coupled to the system bus 808, but may be connected by other interface and bus structures, such as a parallel port, game port, and/or a universal serial bus (USB).

Computing device 800 can operate in a networked environment using connections to one or more remote computers through one or more local area networks (LANs), wide area networks (WANs) and the like. The computing device 801 is connected to a network 814 via a network adapter 813 or alternatively by a modem, DSL, ISDN interface or the like.

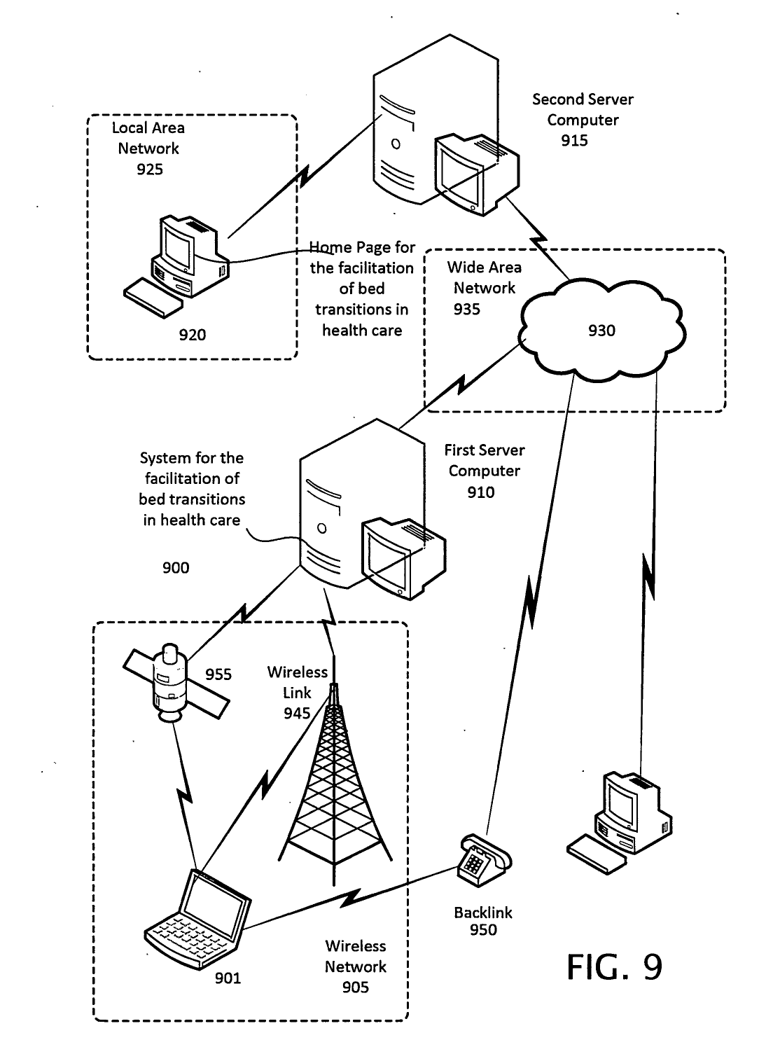

FIG. 9 is an exemplary network 900 in which the facilitation of bed transitions in health care may be implemented. Computer 915 may be a server computer coupled to a user's computer 920 through a conventionally constructed local area network 925.

In the local area network the users computer is typically part of the local area network 925 which may include a plurality conventional computers (not shown) and conventional peripheral equipment (not shown) coupled together utilizing topologies (token, star and the like) and switching equipment known to those skilled in the art. Those skilled in the art will realize that other processor equipped devices such as televisions and VCRs with electronic program guides, cellular telephones, appliances and the like may be coupled to the internet utilizing conventional techniques known to those skilled in the art.

A typical local area network 925 may include a conventionally constructed ISP network in which a number or plurality of subscribers utilize telephone dial up, ISDN, DSL, cellular telephone, cable modem, or the like connections to couple their computer to one or more server computers 915 that provide a connection to the world wide web 935 via the internet 930.

Wide area network or world wide web 935 is conventionally constructed and may include the internet 930 or equivalent coupling methods for providing a wide area network. As shown a conventionally constructed first server computer 910 is coupled to conventionally constructed second server computer 915 through a conventionally constructed internet connection to the world wide web 930.

In a peer to peer network a Peer computer 940 is conventionally constructed to couple to the internet 930 utilizing peer to peer network technology. Peer computer 940 may couple to a plurality of similarly connected peer computers in a peer to peer network (not shown), or to other computers 901, 920 that are part of conventionally constructed networks 925, 935.

In a conventional wireless network 905 a conventionally constructed computer 901 is coupled to the internet 930 via a conventionally constructed wireless link 945. The wireless link may include cellular, and satellite technology 955 to provide the link. Such a wireless network may include a conventionally constructed first server computer 910, typically provided to manage connections to a wide area network such as the internet. Those skilled in the art will realize that the computer 901 may be embodied as a processor coupled to the electronics of an automobile, and referred to as an automotive processor. Such a processor coupled to the internet may be used to find directions, report trouble or communicate with global positioning systems to determine position.

A conventionally constructed back link may be provided to efficiently provide an additional channel to couple to the internet. For example in situations where communication is one way in nature, the back link may provide communications in the opposite direction. An example would be viewing a listing of available on demand movies and ordering a selection via telephone 940. Those skilled in the art will realize that back links may equivalently be provided by cellular telephones, cordless telephones, paging devices and the like.

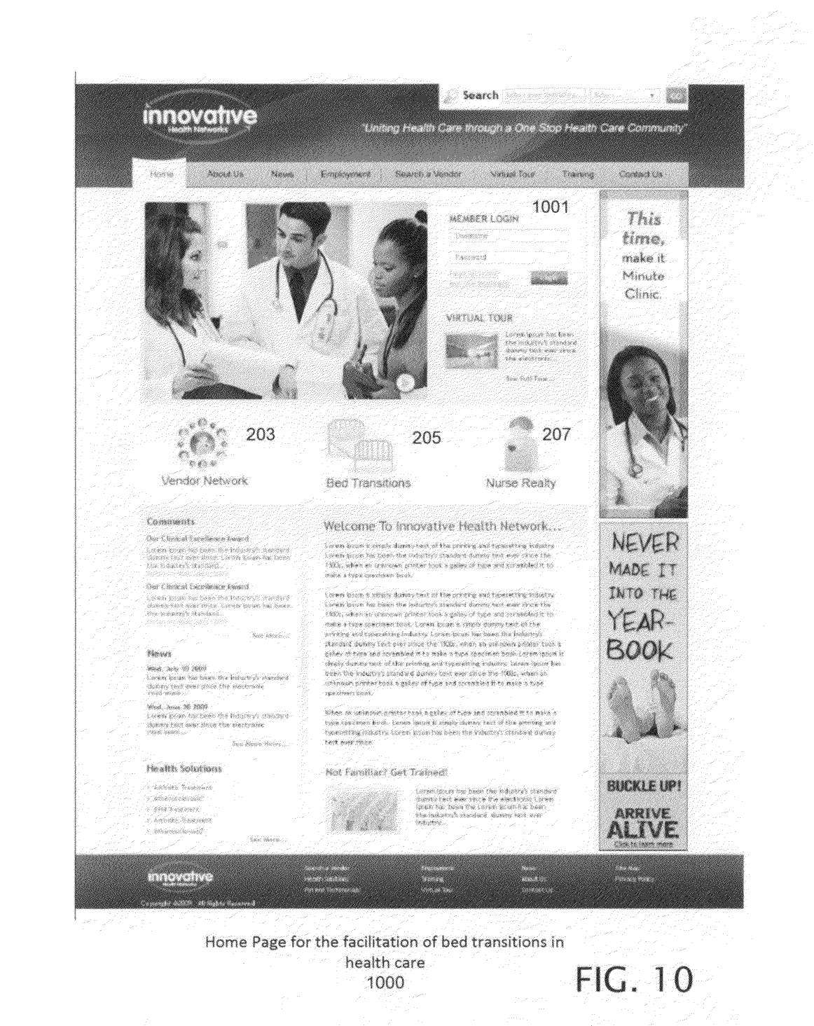

FIG. 10 is an exemplary home page for the facilitation of bed transitions in health care system 300. The home page shown may provide access to the vendor network 203, bed transitions 205, and nurse realty 207 subsystems. A logon 1001 is also provided in order to access those systems.

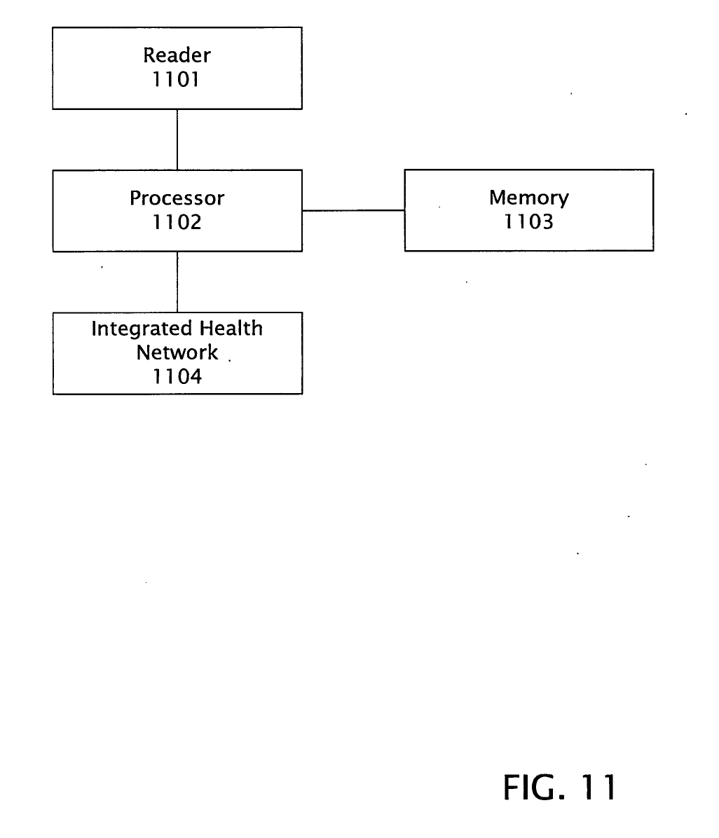

FIG. 11 is a block diagram if an identity verification device. An identity verification device 1101 may be a card reader, of the magnetic stripe variety, a reader suitable for interfacing with encrypted identity chips, or equivalent identity verification devices, preferably those that provide a secure interface. The reader 1101 is coupled to a processor 1102 operating in cooperation with a memory 1103 which control operation of the card reader and also control transmission of identity data collected from a user and transmitted over an integrated health network 1104 as described herein in a HIPPA compliant manner. In particular the device may be configured to function with an encrypted identity chip, that may be integrated into an ID card or equivalent device.

Those skilled in the art will realize that the process sequences described above may be equivalently performed in any order to achieve a desired result. Also, sub-processes may typically be omitted as desired without taking away from the overall functionality of the processes described above.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. An identification device for the facilitation of credential verification bed transitions in health care system comprising:
an identification card reading device including:
a detecting device:
a processor coupled to the care reading device; and
a memory coupled to the processor containing instructions for verifying a user's identity and transmitting it to a facility a vendor network subsystem where the user wishes to become qualified as a certified service provider.

2. The identification device for the facilitation of credential verification bed transitions in health care system of claim 1 in which the identification card reading device is a magnetic stripe card reading.

3. The identification device for the facilitation of credential verification bed transitions in health care system of claim 1 in which the identification card reading device is an identification chip reader.

4. The identification device for the facilitation of credential verification bed transitions in health care system of claim 3 in which an identification chip being read contains encrypted data in compliance with HIPPA privacy standards.
